(19) United States
(12) Patent Application Publication
(10) Pub. No.: US 2011/0002558 A1
(43) Pub. Date: Jan. 6, 2011

(54) HOODED BAG WITH RECLOSABLE TOP

(76) Inventor: GARY F. SARGIN, Green Bay, WI (US)

Correspondence Address: DUANE MORRIS LLP - Philadelphia;IP DEPARTMENT, 30 SOUTH 17TH STREET, PHILADELPHIA, PA, 19103-4196, US

(21) Appl. No.: 12/496,813

(22) Filed: Jul. 2, 2009

(51) Int. Cl. B65D 33/16; B31B 1/90

(52) U.S. Cl. 383/59; 493/214

(57) ABSTRACT

A bag has an elongated bag opening held closed by a fastener assembly, wherein the fastener assembly has a first fastening member and a second fastening member attached along respective sides of the bag opening, and a sliding actuator to interlock or to unlock the first fastening member and the second fastening member. The bag opening is covered by a hood having a section covering the bag opening, and having other sections secured to the first fastening member and the second fastening member, to resist tampering by cutting or peeling, and the sliding actuator protrudes outwardly from the hood for inspection to detect tampering.

### FIELD OF THE INVENTION

The present invention relates to a package in the form of a bag adapted with a fastener assembly and a hood to cover the fastener assembly and to resist opening of the bag by drop testing or rough handling of a bag filled with contents. The bag can be held upside down with clamps while being filled with contents.

### BACKGROUND

U.S. Pat. No. 7,165,887 discloses a reclosable bag that is opened and closed by a zipper. Sides of the bag form a continuous loop that covers the entire zipper including a slide actuator of the zipper. The loop is formed from sides of the bag itself, and not from a separate sheet. The loop is removed by tearing along perforated weakened areas of the loop. Due to the perforated weakened areas, the loop is weakened and is unable to reinforce the holding power of the zipper to prevent accidental opening of the zipper. Moreover, the cover completely covers the zipper including the slide actuator, which conceals the zipper from inspection to detect tampering.

U.S. Pat. No. 7,237,953 discloses a bag that is opened and closed by a zipper. Front and rear walls of the bag extend above the zipper and are bonded together. The cover is arranged loosely over the zipper, such that the cover is unable to reinforce the holding power of the zipper. The cover over the entire zipper conceals the zipper from inspection to detect tampering. Such tampering can be performed by cutting through the cover easily and cleanly with a sharp tool to gain access to the zipper and the interior of the bag. Following tampering, the damage to the cover can be repaired by applying glue to conceal that the cover was cut. The repaired cover falsely appears to be wholly intact and untampered with. The repaired cover conceals the entire zipper including the slide actuator from inspection to detect tampering.

The patented bags are unable to provide a flat support for the bag while the bag is being filled with contents. Moreover, the closure fastener provides an uneven surface while the bag attempts to stand on the closure fastener while upside down and being filled with contents.

A bag, having a tuck forming geometry and a flat bag configuration and beads of adhesive material for closing and sealing an end of the bag, is disclosed by PCT Application No. PCT/US08/67478, filed Jun. 19, 2008 (attorney docket E4919-00108) claiming the benefit of U.S. Provisional Application 60/945,176 filed Jun. 20, 2007 (attorney docket E4919-00102) and claiming the benefit of U.S. Provisional Application 60/968,718, filed Aug. 29, 2007 (attorney docket E4919-00115).

### SUMMARY OF THE INVENTION

The invention relates to a bag having a bag opening formed by a front panel, a rear panel and side panels, a fastener assembly for opening and closing the bag opening and a hood covering portions of the fastener assembly and portions of the bag, and the hood is adhered by an adhesive material to portions of the bag to deter tampering, and to cover and seal the bag opening.

According to an embodiment of the invention, a bag has a fastener assembly with a sliding actuator to open and close a bag opening. The fastener assembly is covered by a hood adhered by adhesive material to augment the holding power of the fastener assembly, wherein the adhesive material resists tampering by cutting or peeling, and the sliding actuator protrudes outwardly from the hood for inspection to detect tampering.

### BRIEF DESCRIPTION OF THE DRAWINGS

Embodiments of the invention will now be described by way of example with reference to the accompanying drawings.

FIG. 1 is an isometric view of a bag having a reclosable fastener assembly and a tamper resistant hood that augments the holding power of the fastener assembly and provides a tear-through tape covering a tear strip.

FIG. 1A is a fragmentary section view of the reclosable fastener assembly and the tamper resistant hood on the bag disclosed by FIG. 1.

FIG. 1B is a view similar to FIG. 1A of an alternative embodiment of the reclosable fastener assembly prior to assembly of the tamper resistant hood.

FIG. 2 is a fragmentary isometric view of the bag of FIG. 1 in a process of forming a flat top end of the bag.

FIG. 3 is a fragmentary isometric view of the bag of FIG. 1 having a different tamper resistant hood that is notched for exposing ends of a tear strip.

### DETAILED DESCRIPTION

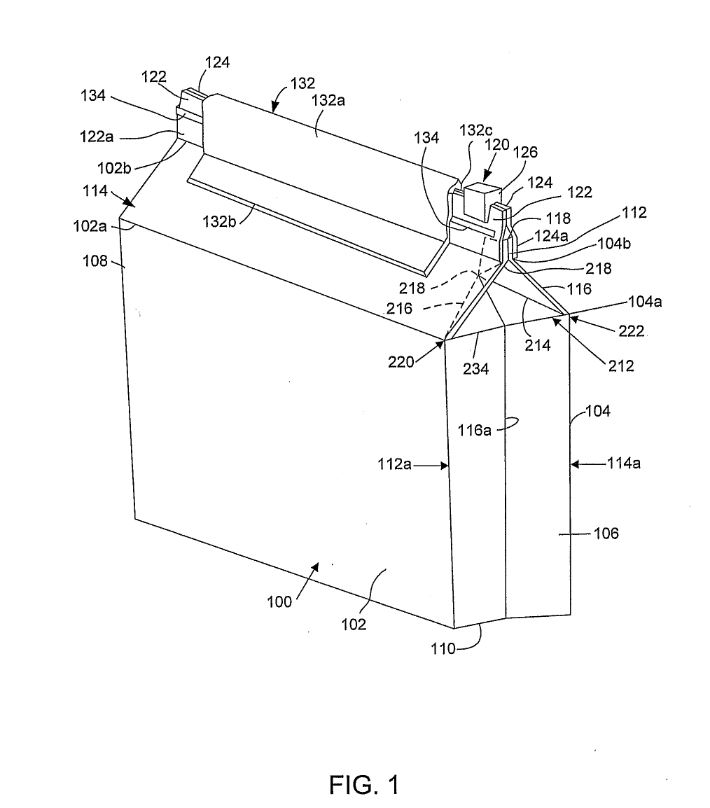

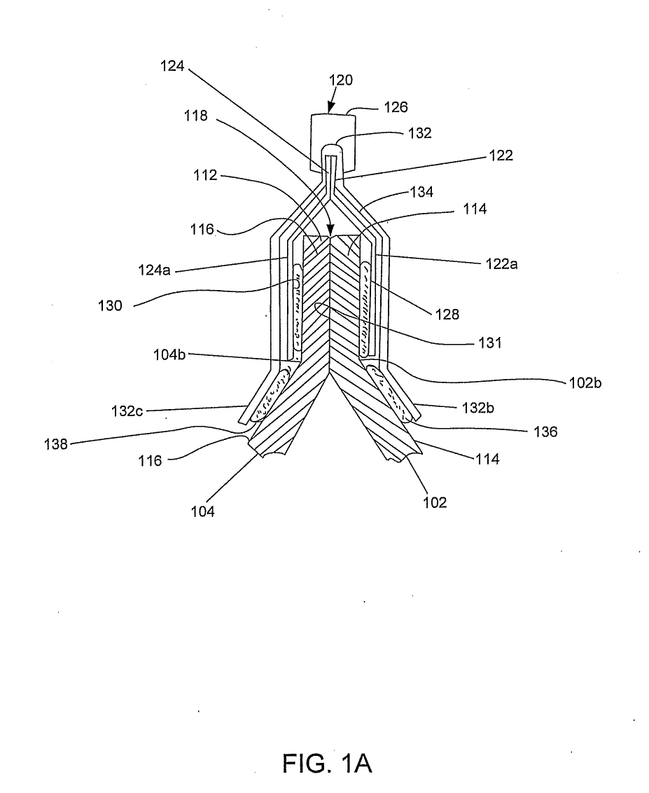

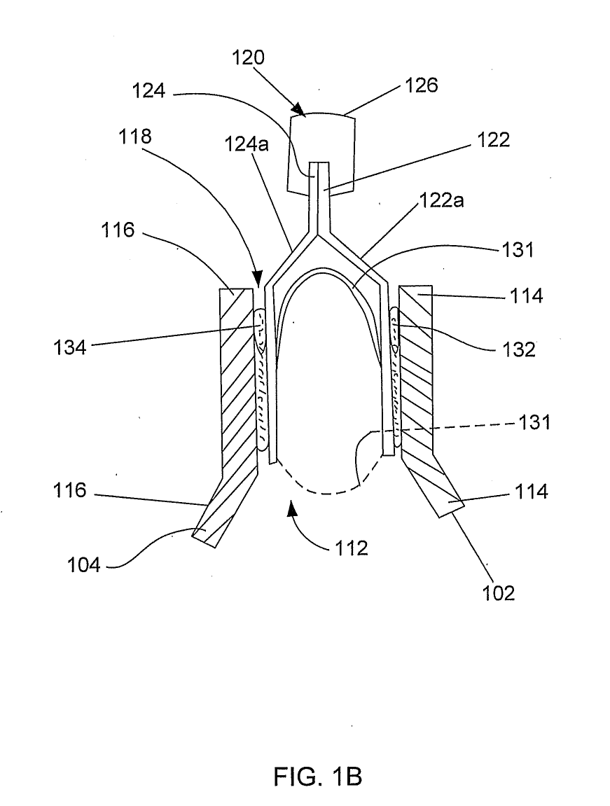

With reference to FIG. 1, a package in the form of a bag 100 comprises a front panel 102, a rear panel 104 and opposite side panels 106, 108, which surround an interior of the package 100. The package 100 includes an elongated bottom opening 110 through which contents are received to fill the package 100. The bottom opening 110 can be closed and sealed after the bag 100 has been filled with contents.

An elongated top end 112 of the package 100 is at an opposite end from the bottom opening 110 of the package 100. The top end 112 is closed while the bag is filled with contents. While being filled with contents, the front panel 102 and the rear panel 104 have a tendency to form respective folds 102a, 104a, which tend to form when the bag is expanded for receiving its contents.

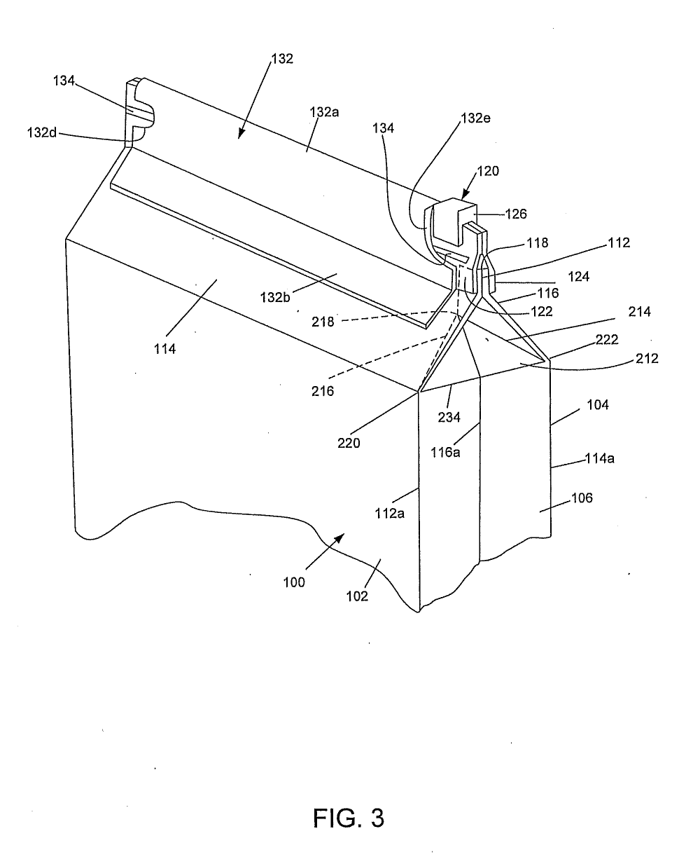

The front panel 102 and the back panel 104 have converging portions 114, 116, FIGS. 1A and 1B, that meet and abut each other along the bag top end 112. In FIG. 1A, the bag diagonal converging portions 114, 116 on respective front and back bag panels 102, 104 are folded along respective creases 102b, 104b to extend vertically upward at an opening 118 of the bag 100. The opening 118 extends transversely along the top end 112 of the bag 100. The opening 118 is initially closed by a reclosable fastener assembly 120. A similar bag 100 is disclosed by FIG. 3.

With reference to FIG. 1, an embodiment of the reclosable fastener assembly 120 comprises an elongated first fastening member 122 and an elongated second fastening member 124 that releasably interlock by displacement of a sliding actuator 126 over the fastening members 122, 124 to close and seal the opening 118. Sliding the actuator 126 in an opposite direction will unlock the first fastening member 122 and the second fastening member 124 from each other, which allows separation of the portions 114, 116 to open the opening 118. A similar fastener assembly 120 is disclosed by FIG. 3.

The first fastening member 122 is attached to exterior surfaces of the bag panels 102, 104, when the exterior surfaces are impervious film layers. For example, the bag panels 102, 104 can be laminated layers of impervious films of compostable polypropylene or polyethylene. Alternatively, an exterior layer can be an impervious polymer film, preferably compostable polypropylene, laminated to an interior layer that can be a woven compostable polypropylene layer. In FIG. 1A the elongated first fastening member 122 has an elongated flange 122a attached and sealed by a bead of hot melt adhesive material 128, including but not limited to a hot melt adhesive or a hot melt polymer sealant, lengthwise along the elongated first side 114 of the front panel 102 adjacent to the opening 118. Similarly, in FIG. 1A, an elongated flange 124a of the elongated second fastening member 124 is attached and sealed by a bead of hot melt adhesive material 130, including but not limited to a hot melt glue or a hot melt polymer sealant, along the elongated second side 116 of the back panel 104 adjacent to the opening 118. For example, the beads of hot melt adhesive material 128, 130 are applied along the undersides of the flanges 122a, 124a. Alternatively, the beads of hot melt adhesive material 128, 130 are applied along the sides 114, 116 of the bag opening 118. The flanges 122a, 124a are assembled over the sides 114, 116 of the bag opening 118 with the hot melt adhesive material 128, 130 between the flanges 122a, 124a and the portions 114, 116 of the bag opening 118. Pressure, with or without heat, is applied to compress the hot melt adhesive material 128, 130 and adhesively bond the flanges 122a, 124a to the portions 114, 116 of the bag opening 118.

In FIG. 1A, interior portions 114, 116 of the bag opening 118 can be abutted against each other, or can be bridged by a frangible web 131 of plastic film between them, either of which prevents contents of the bag 100 from contaminating the fastener assembly 120. However, when the bag 100 is opened, the frangible web 131, if present, is easily broken apart by hand to gain access to the bag contents.

FIG. 1B discloses the fastening members 122, 124 attached to interior surfaces of the bag panels 102, 104, when the interior surfaces are impervious film layers. For example, the bag panels 102, 104 can be laminated layers of impervious films of compostable polypropylene or polyethylene. Alternatively, an interior layer can be an impervious polymer film, preferably compostable polypropylene, laminated to an exterior layer that can be a woven compostable polypropylene layer. The flanges 122a, 124a of the fastening members 122, 124 overlap the interiors of the portions 114, 116 of the bag opening 118, and are adhered and sealed thereto by beads of hot melt adhesive material 132, 134, including but not limited to a hot melt glue or a hot melt polymer sealant. For example, the beads of hot melt adhesive material 132, 134 are applied along the undersides of the flanges 122a, 124a. Alternatively, the beads of hot melt adhesive material 132, 134 are applied along the sides 114, 116 of the bag opening 118. The flanges 122a, 124a are assembled over the sides 114, 116 of the bag opening 118 with the hot melt adhesive material 132, 134 between the flanges 122a, 124a and the portions 114, 116 of the bag opening 118. Pressure, with or without heat, is applied to compress the hot melt adhesive material 132, 134 and adhesively bond the flanges 122a, 124a to the interior woven bag layer at the sides 114, 116 of the bag opening 118.

Further FIG. 1B discloses an embodiment in which a frangible web 131 bridges between the interior sides of the flanges 122a, 124a of the fastener assembly 120. FIG. 1B discloses the fastener assembly 120 prior to assembly of the hood 132. The frangible web 131 extends downwardly, shown by the dotted line, from the flanges 122a and 124a while the flanges 122a, 124a are assembled to the bag portions 114, 116. The frangible web 131 can invert to extend upward in FIG. 1B, which can occur while the bag 100 is upside down. For example, the bag can be upside down while being filled with contents through the open bottom 110. In FIG. 1B the bag portions 114, 116 are spread apart for purposes of illustration, and are moveable toward each other to provide a minimal dimension for coverage by a hood 132, FIG. 1.

The embodiment of the bag 100 in FIG. 1 is a pinch-top bag 100 wherein the portions 114, 116 of the opening 118 are pinched together to close the opening 118. Further, FIG. 1 discloses the opening 118 as being sealed by the fastener assembly 120. The interlocked fastening members 122, 124 provide holding power to hold the opening 118 closed.

In FIG. 1, an elongated hood 132 is adapted to cover the opening 118 of the pinch-to-close bag 100, while the opening 118 is closed and sealed by the fastener assembly 120. The hood 132 is separate from the fastener assembly 120 and from the other parts of the bag 100. The hood 132 has an elongated central section 132a, and has other sections in the form of elongated flanges 132b and 132c unitary with the central section 132a. The central section 132a covers the bag opening 118.

In FIGS. 1 and 1A, an elongated tear strip 134 is adhered to an underside of the central section 132a of the hood 132. The tear strip 134 and the hood 132 extend transversely across the bag 100 and parallel to the longitudinal flanges 122a, 124a of the reclosable fastener assembly 120. Opposite ends of the tear strip 134 extend beyond the corresponding ends of the hood 132 to adapt for grasping and pulling. Alternatively, one or both of the ends of the tear strip 134 extend beyond the hood 132 to at least the gusseted side panels 106, 108 of the bag 100. Each of the ends of the tear strip 134 is individually adapted to be grasped and pulled outward to tear transversely through the hood 132, and sever the hood 132, such that the central section 132a of the hood 132 is preferably severed completely, to access the fastener assembly 120 and the bag opening 118. Thus, the hood 132 provides a tape of adequate tensile strength covering the tear strip 134. The hood 132 is free of perforations that would weaken the hood 132 and encourage tearing or failing in tension. Thus the hood 132 has a sufficient tensile strength to withstand drop testing or rough handling of the bag 100 when filled with contents.

FIG. 3 discloses another version of the hood 132 as having a feature of a notch 132d for exposing a corresponding end of the tear strip 134, wherein the notch 132d provides a beginning of a tear through the hood 132, and a direction for continuing the tear. The notch 132d is in the flange 132b of the hood 132. Another notch 132e can be provided for exposing a corresponding other end of the tear strip. The notch 132e is optionally enlarged to further expose the sliding actuator 126 of the fastener assembly 120, as well as, the other end of the tear strip 134. Each of the notches 132d, 132e tend to weaken the tensile strength of the hood 132. To minimize a weakness in tensile strength, the notches 132d, 132e are rounded in construction to distribute tensile forces and to minimize an apex for each notch 132d, 132e that would tend to concentrate forces as would an apex of a V-shaped notch.

Moreover, to provide adequate tensile strength, even when notched with the notches 132d, 132e, the hood 132 of FIG. 1 or of FIG. 3 is a composite sheet, including, but not limited to a woven or nonwoven polymer layer and an impervious layer of polymeric film in which the layers are laminated or kept as separate layers. The bag 100 when constructed as a composite sheet of similar construction to that of the hood 132, presents a compatible appearance of the hood 132 and the bag 100. The sheet of the hood 132 is continuous, such that it resists tearing except where the tear strip 134 is used to tear through the hood 132. Moreover, the hood 132 is adhered by adhesive material, which increases the tensile strength of the hood 132, as well as, seals the hood 132 to the bag 100 to seal the top end 112 of the bag 100.

In FIG. 1A, the hood 132 is adhesively secured to the bag 100 by a layer of adhesive material including, but not limited to a cold melt or hot melt adhesive material or other adhesive material layer 136, 138 adhering and sealing the undersides of the elongated flanges 132b, 132c of the hood 132 to the flanges 122a, 124a of the fastener assembly 120 and to at least the portions 114, 116 of the bag front panel and back panel. The flanges 132b, 132c of the hood 132 are assembled to overlap portions of the flanges 122a, 124a of the fastener assembly 120 and to overlap the bag sides 114, 116. Alternatively, the adhesive material 136, 138 is applied to corresponding flanges 122a, 124a of the fastener assembly 120 and the bag sides 114, 116. Pressure, with or without heat, is applied to the overlapped components for the adhesive material 136, 138 to faun adhesive bonds. Commercial sources for cold melt and hot melt adhesive materials and applicators include, but are not limited to, Glue Machinery Corporation, Baltimore Md., U.S.A.

According to alternative embodiments of the invention, the adhesive material 136, 138 can be applied to the bag sides 114, 116 or to the undersides of the elongated flanges 132b, 132c of the hood 132. Pressure, with heat, if needed, is applied to the overlapped components for the adhesive material 136, 138 and the further adhesive material on the portions 114, 116 of the bag 100 to form adhesive bonds.

In FIG. 1A, the adhesive material 136, 138 is present over the surface areas under the hood 132, except that the central section 132a of the hood 132 is free of adhesive material 136, 138. The central section 132a of the hood 132 covers the bag opening 118 being held closed by the fastener assembly 120, and is free of adhesive material to avoid migrating the adhesive material 136, 138 into the fastener assembly 120 and into the bag opening 118. Further, the central section 132a of the hood 132 over the tear strip 134 is free of the adhesive material 136, 138 to allow the tear strip 134 to tear through the hood 132. Upon being torn by the tear strip 134, the hood 132 becomes torn open along its central section 132a to access the bag opening 118 being held closed by the fastener assembly 120. The fastener assembly 120 becomes free of the torn open hood 132, and is permitted to open by slidable displacement of the sliding actuator 126 to open the fastening members 122, 124.

FIG. 1A further discloses the manner in which the hood 132 covers respective portions of the bag 100, the fastener assembly 120 and the tear strip 134. The hood 132 of FIG. 1 and the hood 132 of FIG. 3 are similarly described with reference to FIG. 1A. The hood 132 engages and covers the elongated fastener assembly 120 lengthwise an essential amount to augment the holding power of the interlocked fastening members 122, 124, which prevents unwanted opening of the fastener assembly 120 under the weight of the bag contents, during filling of the bag with the contents, or when the contents shift during drop testing of the bag or during rough handling of the bag.

The bag 100 is observed in FIGS. 1, 2 and 3 as having a tamper resistant structure. In FIG. 1, the elongated central section 132a of the hood 132 covers and snugly conforms against the elongated fastener assembly 120 while the fastener assembly 120 is closed with the fastening members 122, 124 being interlocked. The other sections comprising the elongated flanges 132b and 132c of the hood 132 cover and adhere to exteriors of the respective first fastening member 122 and the second fastening member 124 of the reclosable fastener assembly 120. The hood 132 prevents opening of the fastener assembly 120. Further, the hood is exposed for inspection as a device separate from the bag panels 102, 104 to determine whether tampering of the hood 132 has taken place.

Tampering with the bag 100 by cutting through the hood 132 is made difficult due to the presence of the adhesive material 136, 138, since the adhesive material 136, 138 is physically tough and resists cutting. Further, tampering with the bag 100 by peeling to remove the hood 132 is avoided, due to the holding power of the adhesive material 136, 138 resisting peeling of the adhered portions of the hood 132. The hood 132 is observed in FIG. 1 to be free of damage due to tampering, and the central section 132a is observed to be free of damage due to tampering. The sliding actuator 126 protrudes outwardly from one end of the hood 132 to display the slide actuator 126 as being free of damage due to tampering. Such a feature eliminates a disadvantage of a cover that would conceal the sliding actuator 126 from an inspection to detect tampering. The hood 132 covers the first fastening member 122 and the second fastening member 124 to prevent tampering by opening the fastener assembly 120. Further, the ends of the tear strip 134 protrude outwardly from respective ends of the hood 132 for inspection to exhibit no signs of damage due to tampering. Thus, the tear strip 134, the sliding actuator 126 and the intact hood 132 are observable as being wholly intact, thus, free of damage due to tampering.

Each of FIGS. 1 and 3 discloses a tuck forming, folding geometry 212 fabricated in each gusseted side panel 106, 108 near the top end 112 of the bag 100. The folding geometry 212 comprises a first set of intersecting diagonal fold lines 214, 216 intersecting at a first apex 218 approximately on a center gusset fold line 116a and extending diagonally to respective junctions 220, 222 with the longitudinal folded edges 112a, 114a. A transverse crease 234 extends between the junctions 220, 222. Each of the side panels 106, 108 is folded inwardly along the diagonal fold lines 214, 216 and inwardly along the crease 234, which draws top edges of the side panels 106, 108 together, and which draws together the diagonal portions 114, 116 of the bag top end 112, as shown in FIGS. 1 and 1A. Moreover, the bag 100 is manufactured in a flat configuration, as a collapsed tube, which is obtained by folding externally along the longitudinal folded edges 112a, 114a, and folding inwardly along the longitudinal crease 116a.

Each of FIGS. 1 and 3 discloses the bag 100 in a closed configuration. The top end 112 of the bag 100 can collapse to lie flat.

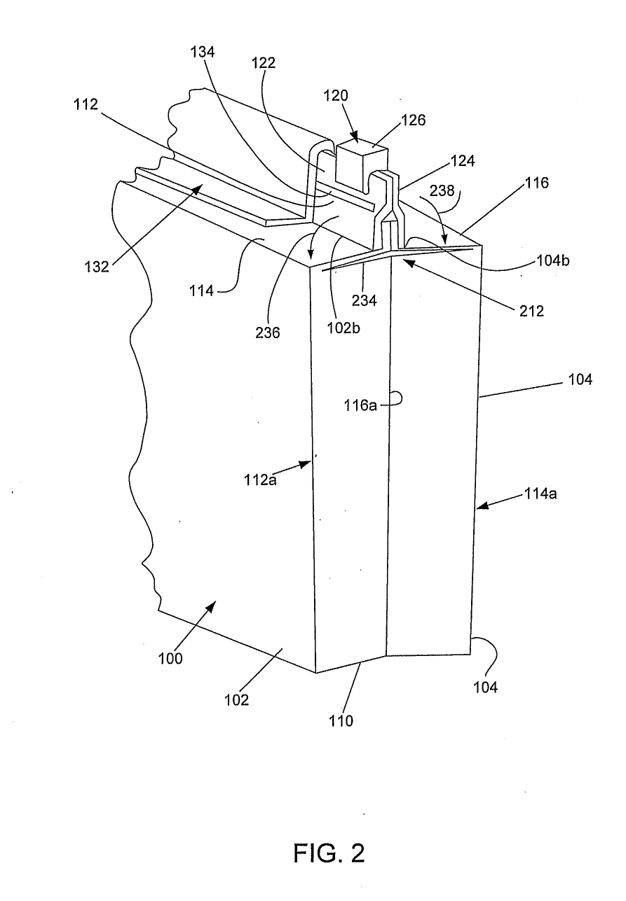

FIG. 2 discloses how the top end 112 of the bag 100 of FIG. 1 collapses to lie flat. Further, FIG. 2 applies to the bag 100 of FIG. 3 that collapses in a similar way. In FIG. 2, the folding geometry 212 is collapsed by folding and flattening along the fold lines 214, 216 and 234 in FIG. 1. In FIG. 1, the converging diagonal portions 114, 116 are disclosed in FIG. 2 as being folded and flattened to form an essentially folded flat, or substantially folded flat, top end 112 of the bag 100. The flat top end 112 is orthogonal or perpendicular to each of the first panel 102, the second panel 104 and gusseted side panels 108, 110.

In FIG. 2, the fastener assembly 120 is adapted to lie flat against the flat top end 112 of the bag 100. The fastener assembly 120 can be pivoted in the direction of the arrow 236 to fold the bag along the crease 102b and for the fastener assembly 120 to lie flat against the side 114. Alternatively, the fastener assembly 120 is pivoted in the direction of the arrow 238 to fold the bag along the crease 104b and lie flat against the side 116. Thus, a flat, top end 112 of the bag 100 is provided with the bag folded along the crease 102b or folded along the crease 104b, and the fastener assembly 120 that can lie flatly against the flat, top end 112. The side panels 106, 108 are folded flatly, which provides a flat bag 100 for shipping and handling. Further, the flat bag 100 is ready for filling with contents through an opposite open end of the bag 100. The bag 100 can be held upside down with clamps while being filled with the contents through the opposite open end 110 of the bag 100. The contents will expand the bag 100 to a configuration shown in FIG. 1, by unfolding the previously folded side panels 106, 108 and unfolding the bag 100 further from its configuration disclosed by FIG. 2 to its configuration disclosed by FIG. 1. The contents will expand the bag 100 by forming the diagonal sides 114, 116 and the folds 102a, 104a. After filling the bag 100 with contents, the opposite open end 110 of the bag is closed and sealed.

Alternatively, while the bag 100 is being filled with contents through the open bottom end 110 of the bag 100, the bag 100 can stand upright on the flat top end 112. The flat top end 112 is orthogonal or perpendicular to each of the first panel 102, the second panel 104 and gusseted side panels 106, 108 to support the bag 100 upright, while the bag 100 is upside down.

After the bag 100 is filled with contents, the open bottom end of the bag 100 is closed and secured. For example, the bottom end 110 of the bag 100 is closed by inwardly folding the center gusset fold line or crease 116a of each gusseted side 106, 108 adjacent to the bottom end 110, followed by pinching together the panels 102, 104 adjacent to the bottom end 110. The bottom end 110 is secured and sealed by being sewn or adhesively taped, glued or adhesively sealed with adhesive material, for example, by applying a bead or beads of adhesive material inside the bottom end 110 of the bag 100 and closing the bottom end 110 of the bag 100 to adhere the adhesive material and maintain the bottom end 110 closed and sealed.

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

Patents and patent applications referred to herein are hereby incorporated by reference in their entireties. Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A bag comprising:
a bag opening formed by a front panel, a rear panel and side panels;
a fastener assembly for opening and closing the bag opening;
a hood covering portions of the fastener assembly and portions of the bag, and the hood is secured to the portions of the fastener assembly and to the portions of the bag to deter tampering, and to cover and seal the bag opening.

2. The bag of claim 1 wherein the hood has a section covering the bag opening and the hood has other sections adhered to a first fastening member and a second fastening member of the fastener assembly to resist tampering by cutting or peeling; and
a sliding actuator of the fastener assembly protrudes outwardly from the hood for inspection to detect tampering.

3. The bag of claim 1 wherein the hood is separate from the fastener assembly, the front panel, the rear panel and the sides of the bag, and is secured by adhesive material, heat sealing or ultrasonic bonding.

4. The bag of claim 1, wherein the hood is secured and sealed to the front panel and the rear panel.

5. The bag of claim 3 wherein the hood is secured and sealed further to the front panel and the rear panel.

6. The bag of claim 3 wherein the bag opening is free of the adhesive material, heat sealing or ultrasonic bonding.

7. The bag of claim 1, comprising:
a tear tape attached to an interior of the section of the hood covering the bag opening.

8. The bag of claim 1 wherein a frangible web bridges between interior sides of flanges of the fastener assembly.

9. The bag of claim 1 wherein interior portions of the bag opening are bridged by a frangible web.

10. The bag of claim 1, comprising:
each side panel having a tuck forming, folding geometry adapted to fold flat while adjacent to the bag opening.

11. The bag of claim 10 wherein portions of the front panel and rear panel meet along the bag opening, wherein the portions fold flat to provide a flat end of the bag.

12. The bag of claim 11 wherein the portions of the front panel and rear panel pivot, and the fastener assembly pivots to lie flat on the flat end of the bag.

13. A method of making the bag of claim 1, comprising:
forming the bag as a tube having the bag opening;
attaching the first fastening member and the second fastening member of the fastener assembly along respective sides of the bag opening;
covering the bag opening with said section of the hood and adhering the other sections of the hood to the first fastening member and the second fastening member to resist tampering by cutting or peeling; and
protruding the sliding actuator outwardly from the hood to display the slide actuator as being free of damage due to tampering.

14. The method of claim 13, comprising:
attaching a tear tape to an interior of the section of the hood prior to covering the bag opening with said section of the hood.

15. The method of claim 14, comprising:
forming each side of the bag with a tuck forming, folding geometry adapted to fold flat while adjacent to the bag opening.

16. The method of claim 14, comprising:
forming portions of the front panel and rear panel to meet along the bag opening, wherein the portions fold flat to provide a flat end of the bag.

17. The method of claim 14, wherein the portions of the front panel and rear panel pivot, and the fastener assembly pivots to lie flat on the flat end of the bag.
